(19) United States
(12) Patent Application Publication
(10) Pub. No.: US 2010/0259784 A1
(43) Pub. Date: Oct. 14, 2010

(54) IMAGE FORMING APPARATUS AND POWER CONTROL METHOD THEREFOR

(75) Inventor: Kenichi TSUDA, Kanagawa (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/754,389

(22) Filed: Apr. 5, 2010

Related U.S. Application Data
(60) Provisional application No. 61/167,794, filed on Apr. 8, 2009.

(51) Int. Cl. G06F 15/00

(52) U.S. Cl. 358/1.15

(57) ABSTRACT

An image forming apparatus according to an aspect of the present invention includes: an image-formation processing unit configured to perform processing for forming an image; a power control unit configured to control power supply to the image-formation processing unit to make it possible to switch an image formable state for supplying power to enable the image-formation processing unit to immediately perform the processing for image formation and an electricity saving state for reducing the power supply and performing electricity saving; and a power key configured to be once activated to thereby control the power control unit to transition the image forming apparatus from the image formable state to the electricity saving state and activated again to thereby control the power control unit to return the image forming apparatus from the electricity saving state to the image formable state.

### CROSS-REFERENCE TO RELATED APPLICATION

The present invention is based upon the benefit of priority from Provisional Application No. 61/167794 filed on Apr. 8, 2009, the entire content of which is incorporated herein by reference.

### TECHNICAL FIELD

The present invention relates to an image forming apparatus, and, more particularly to an image forming apparatus having a power saving function and a power control method for the image forming apparatus.

### BACKGROUND

Conventionally, in order to save electric power, some image forming apparatus transitions to a power saving mode and turns off a power supply for a part of the apparatus when not in use. As the transition to the power saving mode, the image forming apparatus automatically transitions to the power saving mode when a predetermined time elapses while the image forming apparatus is not used or a user forces the image forming apparatus to transition to the power saving mode because it is unlikely that the image forming apparatus is immediately used.

In any case, to use the image forming apparatus again, it is necessary to return the image forming apparatus from the power saving mode to an image formable mode.

Conventionally, it is necessary to depress an electricity saving key in order to return the image forming apparatus from the power saving mode to the image formable mode. JP-A-2000-132012 discloses, as a second embodiment, an image forming apparatus that has an image formable state and an electricity saving state, transitions from the image formable state to the electricity saving state when a soft switch (a power switch) is depressed, and transitions from the electricity saving state to the image formable state when an electricity saving switch is depressed.

However, a backlight on a display surface is often off in the electricity saving state. In such a case, a user may misunderstand that a power supply is off and depress the power switch. Even if the user depresses the power switch, a state of the image forming apparatus does not change. Therefore, eventually, the user often turns off a main power switch.

The present invention has been devised in view of such a problem and provides an image forming apparatus that can quickly return to the image formable state even if the user misunderstands that the image forming apparatus is stopped in the electricity saving state and a power control method for the image forming apparatus.

### SUMMARY

According to an aspect of the present invention, there is provided an image forming apparatus including: an image-formation processing unit configured to perform processing for forming an image; a power control unit configured to control power supply to the image-formation processing unit to make it possible to switch an image formable state for supplying power to enable the image-formation processing unit to immediately perform the processing for image formation and an electricity saving state for reducing the power supply and performing electricity saving; and a power key configured to be once activated to thereby control the power control unit to transition the image forming apparatus from the image formable state to the electricity saving state and activated again to thereby control the power control unit to return the image forming apparatus from the electricity saving state to the image formable state.

According to another aspect of the present invention, there is provided an image forming apparatus including: an image-formation processing unit configured to perform processing for forming an image; a power control unit configured to control power supply to the image-formation processing unit to make it possible to switch an image formable state for supplying power to enable the image-formation processing unit to immediately perform the processing for image formation, a first electricity saving state for reducing the power supply and performing electricity saving, and a second electricity saving state for reducing the supply of the power by an amount larger than that in the first electricity saving state; and a power key configured to be once depressed to thereby control the power control unit to transition the image forming apparatus from the image formable state to the second electricity saving state and depressed again to thereby control the power control unit to return the image forming apparatus from the second electricity saving state to the image formable state.

According to still another aspect of the present invention, there is provided a power control method for an image forming apparatus including: depressing a power key once to thereby control a power control unit to transition an image forming apparatus from an image formable state to an electricity saving state (the image formable state is a state for supplying power to enable the image forming apparatus to immediately perform processing for image formation and the electricity saving state is a state for reducing the power supply and performing electricity saving. The power control unit can control power supply to an image-formation processing unit and switch the image formable state and the electricity saving state); and depressing the power key again to thereby control the power control unit to return the image forming apparatus from the electricity saving state to the image formable state.

### DESCRIPTION OF THE DRAWINGS

FIG. 1 is a schematic diagram of an image forming apparatus according to a first embodiment of the present invention;

FIG. 2 is a diagram of an operation panel surface of the image forming apparatus shown in FIG. 1;

FIG. 3 is a diagram for explaining an electric configuration example and an electricity saving state of the image forming apparatus shown in FIG. 1;

FIG. 4 is a flowchart for explaining a flow of processing in the first embodiment;

FIG. 5A is a diagram of on and off states of a display lamp in an image formable state and the electricity saving state in the first embodiment;

FIG. 5B is a diagram of on and off states of the display lamp in the electricity saving state in the first embodiment;

FIG. 6 is a diagram for explaining an electric configuration example and an electricity saving state of an image forming apparatus according to a second embodiment of the present invention;

FIG. 7 is a diagram for explaining transition among an image formable state, a first electricity saving state, and a second electricity saving state in the second embodiment;

FIG. 8 is a flowchart for explaining a flow of processing in the second embodiment;

FIG. 9A is a diagram of on and off states of a main power lamp, a power lamp, and an electricity saving lamp key in the image formable state in the second embodiment;

FIG. 9B is a diagram of on and off states of the main power lamp, the power lamp, and the electricity saving lamp key in the first electricity saving state in the second embodiment; and

FIG. 9C is a diagram of on and off states of the main power lamp, the power lamp, and the electricity saving lamp key in the second electricity saving state in the second embodiment.

### DETAILED DESCRIPTION

Image forming apparatuses according to embodiments of the present invention are explained below with reference to the accompanying drawings.

### First Embodiment

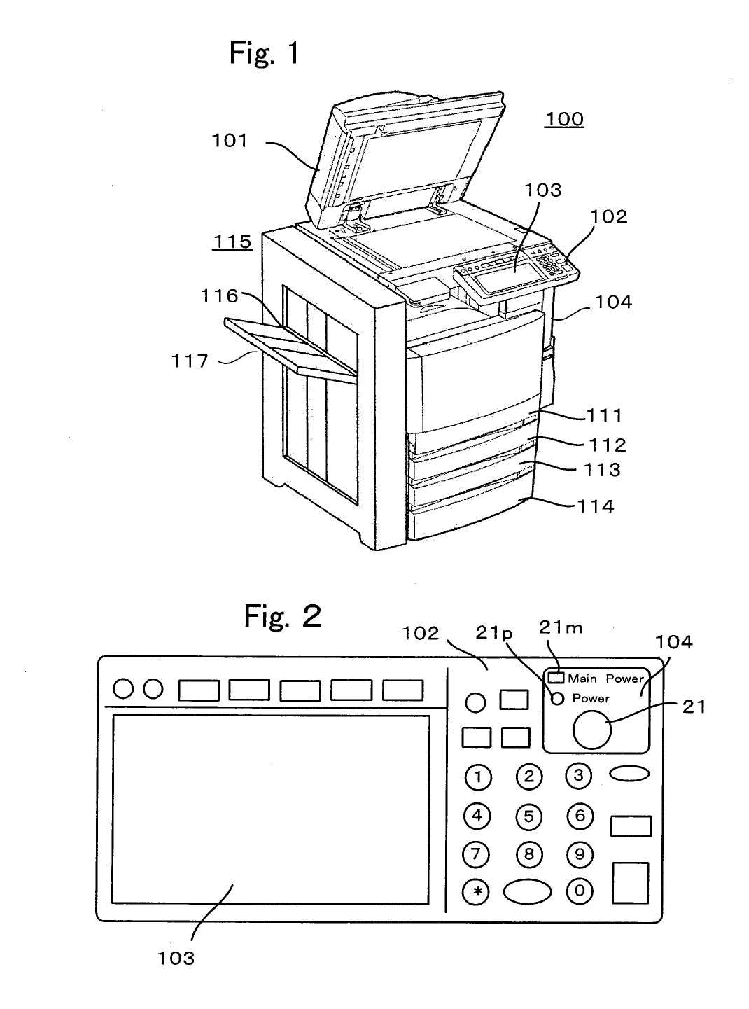

A multifunction peripheral as an image forming apparatus according to a first embodiment of the present invention is schematically shown in FIG. 1.

In an upper part of an image forming apparatus 100, an auto document feeder (ADF) 101 that automatically feeds sheet-like original documents one by one is openably and closably provided. The ADF 101 also functions as a document cover. An operation panel 102 including various operation keys and various display devices for instructing copy conditions and copy start is provided in a front section of an upper surface of the image forming apparatus 100. Various setting and registration buttons are also provided on the operation panel 102. Beside the operation panel 102, a display unit 103 is provided. The display unit 103 displays various kinds of information for a user. When the user is requested to perform input, the user can perform predetermined input by touching the display unit 103.

A handle 104 is provided below the operation panel 102 on the front surface of the image forming apparatus 100 to enable the user to open the main body to see the inside when a paper jam or the like occurs.

Paper feeding cassettes 111, 112, 113, and 114 are detachably provided in a lower part of the image forming apparatus 100. Sheets having different sizes and types are respectively stored in the paper feeding cassettes.

A finishing apparatus 115 is set in contact with the left side of the image forming apparatus 100. In the image forming apparatus 100, a sheet on which a latent image is formed, printed, and fixed as explained later is subjected to processing such as alignment and stapling by the finishing apparatus 115 and discharged from a sheet discharge port 116. The sheet discharged from the sheet discharge port 116 is stacked on a stacking tray 117.

A front view of the operation panel 102 and the display unit 103 is shown in FIG. 2. The operation panel 102 is provided on the right side in front of a user. The display unit 103 is provided on the left side of the operation panel 102.

Number keys from 0 to 9 and sign keys are provided in the center of the operation panel 102. Besides, operation keys for performing various kinds of operation are provided in upper parts of the operation panel 102 and the display unit 103. A power panel 104 is provided on the upper right in the operation panel 102. A power key 21 is provided in the power panel 104. A main power lamp 21m and a power lamp 21p are provided above the power key 21. As explained later, the image forming apparatus 100 transitions to an electricity saving state when the power key 21 is depressed and returns to an image formable state when the power key 21 is depressed again.

The user of the image forming apparatus 100 usually looks at the lamps of the power panel 104 and the display of the display unit 103 and depresses the respective keys on the operation panel 102 to thereby perform desired operation.

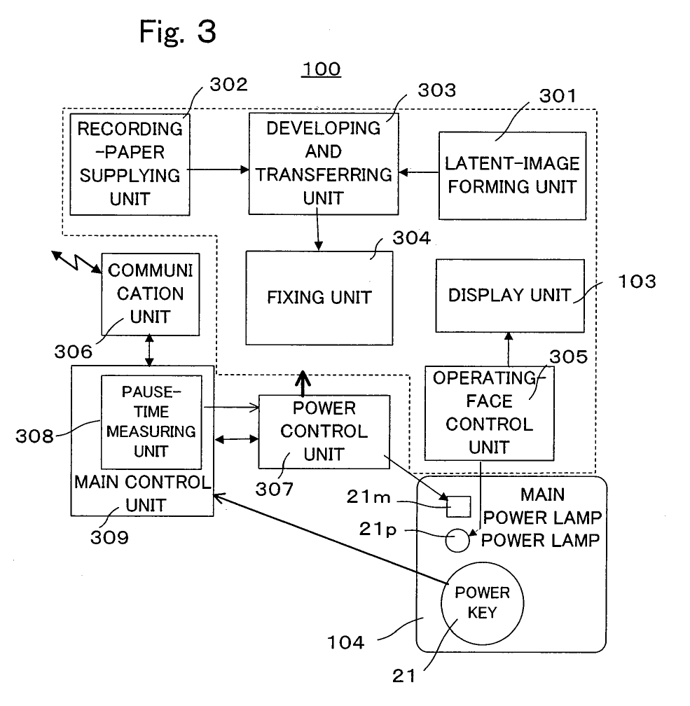

The electric configuration of the image forming apparatus 100 is shown in FIG. 3. The image forming apparatus 100 includes a latent-image forming unit 301 configured to form an electrostatic latent image on a not-shown photoconductive drum, a recording-paper supplying unit 302 configured to supply recording paper, a developing and transferring unit 303 configured to develop, with, for example, a powder toner, the latent image formed by the latent-image forming unit 301 and transfer a toner image onto the recording paper, a fixing unit 304 configured to heat the toner image transferred on the recording paper to thereby fix the toner image, the display unit 103, the power panel 104, an operating-face control unit 305 configured to control the display unit 103 and the main power lamp 21m and the power lamp 21p of the power panel 104, a communication unit 306 configured to perform communication with the outside, a power control unit 307 configured to temporarily stop the supply of electric power to the respective units under predetermined conditions explained later, and a main control unit 309 including a pause-time measuring unit 308 therein.

The latent-image forming unit 301, the recording-paper supplying unit 302, the developing and transferring unit 303, and the fixing unit 304 configure an image-formation processing unit. The display unit 103 displays a state of the image forming apparatus 100 on a display surface thereof.

Pause time is time during which the image forming apparatus 100 is not used. The pause-time measuring unit 308 is, for example, a counter configured to start measurement of time immediately after the use of the image forming apparatus 100 ends.

The pause-time measuring unit 308 sends, to the power control unit 307, a pause time signal indicating that a predetermined time, for example, one minute elapses as the measured pause time while the image forming apparatus 100 is not used. The main control unit 309 sends a key depression signal to the power control unit 307 when the power key 21 is depressed. The power control unit 307 receives the pause time signal from the pause-time measuring unit 308 or the depression signal sent when the power key 21 is depressed and stops the operation of a part of circuits of the image forming apparatus 100. It is undesirable to stop a section that should always be kept operating such as a section having a function of receiving a facsimile signal from the outside including a part of the communication unit 306 and the main control unit 309. The power control unit 307 stops power supply to the other sections that do not need to be kept operating for the time being and stops the operation of the sections.

A state in which any processing of all the functions of the image forming apparatus 100 is possible is referred to as image formable state. A state in which a part of the functions of the image forming apparatus 100 is stopped and electric power is partially reduced is referred to as electricity saving state. In the electricity saving state, the range of units whose power supply is stopped, i.e., which units have their functions stopped is determined, taking a degree of power reduction and time until return to the image formable state into account.

In general, if a larger number of functions are stopped, although a power reducing effect (a power saving effect) is improved, longer time is required until the image forming apparatus 100 returns to the image formable state. On the other hand, if time until the image forming apparatus 100 returns to the image formable state is reduced, the power saving effect in the electricity saving state is deteriorated. It is desirable to stop a section that requires relatively large electric power for operation but does not need to be caused to function for the time being such as the fixing unit 304.

In this example, in order to improve the power saving effect, i.e., increase a power reduction amount, the power control unit 307 stops power supply to, for example, a section surrounded by a dotted line, i.e., the latent-image forming unit 301, the recording-paper supplying unit 302, the developing and transferring unit 303, the fixing unit 304, the display unit 103, and the operating-face control unit 305.

In the case of the electricity saving state, the display unit 103 stops operation. Therefore, as at the time when a power supply for the image forming apparatus 100 is off, a screen of the display unit 103 and the power lamp 21p are off. The operating-face control unit 305 also stops. However, a state of the main power lamp 21m maintains an on or off state before the stop.

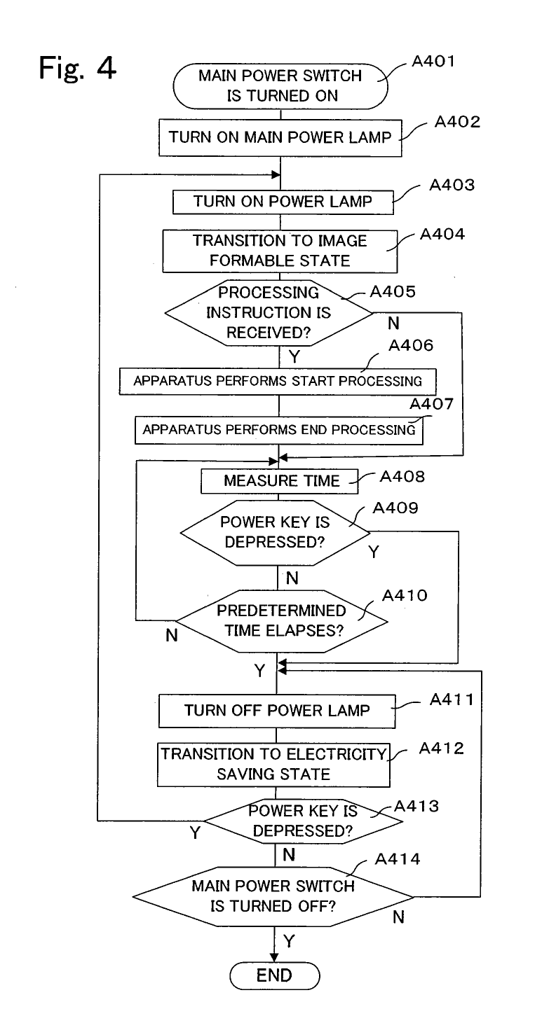

The operation of the image forming apparatus 100 according to this embodiment is explained below with reference to a flowchart shown in FIG. 4.

First, when a not-shown main power switch (hard switch) is turned on in Act A401, in Act A402, the main power lamp 21m on the power panel 104 is turned on. The main power lamp 21m is kept on while the main power switch is on.

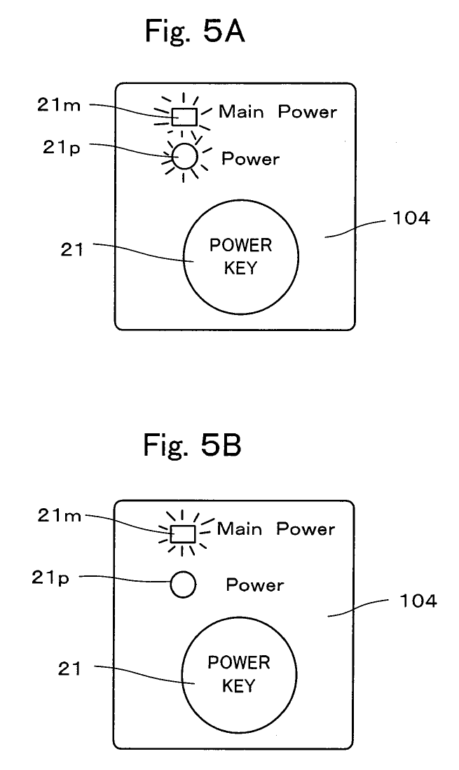

Subsequently, in Act A403, the power lamp 21p is turned on. This indicates that all the sections of the image forming apparatus 100 are operating. In Act A404, the image forming apparatus 100 transitions to the image formable state in which the image forming apparatus 100 can always perform processing. In this state, on the power panel 104, as shown in FIG. 5A, the main power lamp 21m and the power lamp 21p are on. The image forming apparatus 100 can always perform processing instructed by the user.

In Act A405, the image forming apparatus 100 detects whether an instruction for performing processing is received from the user. If the instruction for processing is received (Y in A405), in Act A406, the image forming apparatus 100 performs the instructed processing. For example, if an instruction for copying is received, the image forming apparatus 100 performs copying. In the copying, the image forming apparatus 100 forms, in the latent-image forming unit 301, an electrostatic latent image of an original document on a photoconductive drum (not shown). Then, the image forming apparatus 100 develops, in the developing and transferring unit 303, the electrostatic latent image with a toner. The image forming apparatus 100 transfers, in the developing and transferring unit 303, a toner image onto recording paper supplied from the recording-paper supplying unit 302. The image forming apparatus 100 fixes, in the fixing unit 304, the toner image on the recording paper and then discharges the recording paper to the outside.

When such processing ends in Act A407, in Act A408, the image forming apparatus 100 starts time measurement from a point when the processing ends. The time measurement is performed in the pause-time measuring unit 308 in the main control unit 309.

In parallel to the time measurement, in the next Act A409, the image forming apparatus 100 detects whether the power key 21 is depressed. If the power key 21 is not depressed (N in A409), in Act A410, the image forming apparatus 100 detects whether predetermined time, for example, one minute elapses. This detection is performed when the power control unit 307 receives a pause time signal from the pause-time measuring unit 308.

In the next Act A411, the image forming apparatus 100 turns off the power lamp 21p. In Act A412, the image forming apparatus 100 transitions to the electricity saving state. At this point, the power control unit 307 stops the power supply to the section surrounded by the dotted line in FIG. 3, i.e., the latent-image forming unit 301, the recording-paper supplying unit 302; the developing and transferring unit 303, the fixing unit 304, the display unit 103, and the operating-face control unit 305.

On the other hand, if the power key 21 of the image forming apparatus 100 is depressed by the user in Act A409 (Y in A409), the image forming apparatus 100 skips Act A410, turns off the power lamp 21p in Act A411, and transitions to the electricity saving state in Act A412. Specifically, at this point, the power control unit 307 also stops the power supply to the section surrounded by the dotted line in FIG. 3.

As explained above, the image forming apparatus 100 transitions to the electricity saving state when the predetermined time elapses after the immediately preceding processing ends or when the power key 21 is depressed.

In the electricity saving state, as shown in FIG. 5B, the main power lamp 21m is on but the power lamp 21p is off.

Usually, when considerable time elapses while the image forming apparatus 100 is not used, as indicated on the power panel 104, the image forming apparatus 100 transitions to the electricity saving state and, as shown in FIG. 5B, the power lamp 21p is off. Further, in the electricity saving state, the display of the display unit 103 is often off. In this state, it is likely that the user misunderstands that the power switch is off. However, in this embodiment of the present invention, in the next Act A413, the image forming apparatus 100 detects again whether the power key 21 is depressed. If it is detected in Act A413 that the power key 21 is depressed (Y in Act A413), the image forming apparatus 100 returns to Act A403, turns on the power lamp 21p, and transitions to the image formable state in Act A404.

If the power key 21 is not depressed in Act A413 (N in A413), in Act A419, the image forming apparatus 100 detects whether the main power switch is turned off. When the main power switch is not depressed, the image forming apparatus 100 returns to Act A411, turns off the power lamp 21p, and maintains the electricity saving state in Act A412. Specifically, the power control unit 307 continues to stop the power supply to the section surrounded by the dotted line in FIG. 3. When main power switch is turned off in Act A414, all the units of the image forming apparatus 100 are stopped.

As explained above, according to this embodiment, when the image forming apparatus 100 transitions to the electricity saving state and when the image forming apparatus 100 returns from the electricity saving state to the image formable state, the user only has to depress the same power key. Therefore, there is an effect that the image forming apparatus 100 can easily return to the image formable state.

In the first embodiment, as shown in FIGS. 5A and 5B, the power lamp 21p is on in the image formable state and off in the electricity saving state. However, conversely, the power lamp 21p may be off in the image formable state and on in the electricity saving state.

### Second Embodiment

In the first embodiment, the image forming apparatus 100 has one electricity saving state. As explained above, when the stopped sections in the electricity saving state are increased, although the power saving effect can be improved, time until the image forming apparatus 100 returns to the image formable state increases. Therefore, it is also possible to configure an image forming apparatus to have two electricity saving states, i.e., a first electricity saving state in which the power saving effect is small but the time for return to the image formable state is short and a second electricity saving state in which the power saving effect is large but the time for return to the image formable state is long.

An image forming apparatus according to a second embodiment of the present invention having such two electricity saving states is explained below with reference to the accompanying drawings. In this embodiment, as in the first embodiment, when the image forming apparatus returns from the second electricity saving state with the large power saving effect to the image formable state and when the image forming apparatus transitions from the image formable state to the second electricity saving state, a user depresses the same power key.

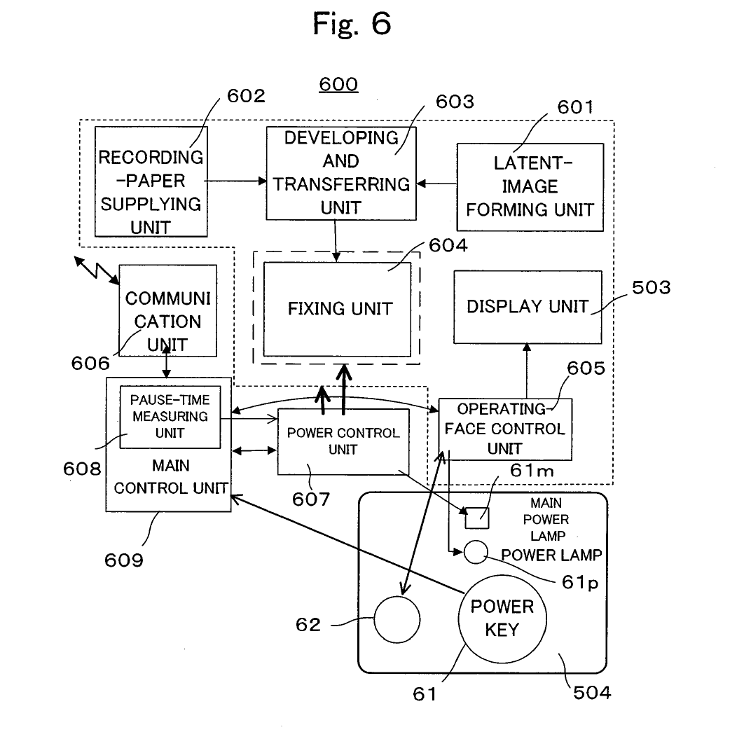

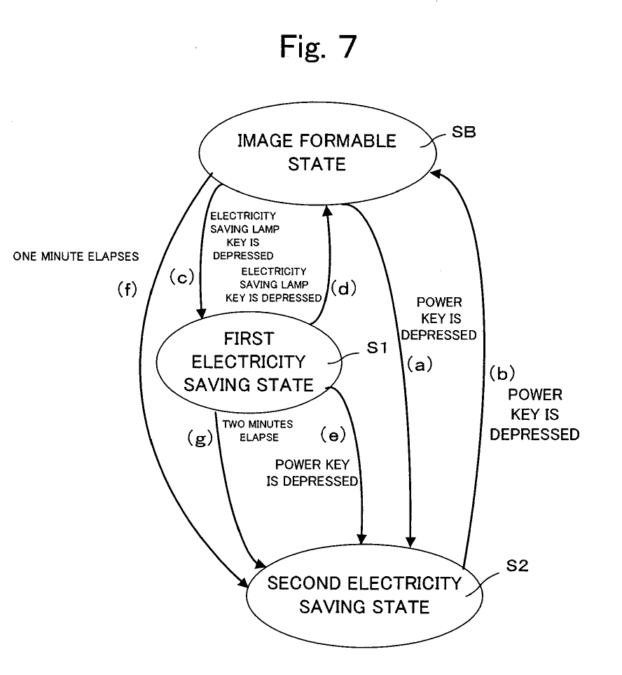

The electric configuration of the image forming apparatus according to the second embodiment is shown in FIG. 6. State transition among the image formable state, the first electricity saving state, and the second electricity saving state in the second embodiment is shown in FIG. 7.

The electric configuration of the image forming apparatus according to the second embodiment shown in FIG. 6 is different from that in the first embodiment shown in FIG. 3 in that the image forming apparatus includes an electricity saving lamp key 62 on a power panel 504 other than a power key 61 and that a power control unit controls the two electricity saving states. When the electricity saving lamp key 62 is depressed when the image forming apparatus is in the image formable state, the image forming apparatus transitions to the first electricity saving state and the electricity saving lamp key 62 is turned on. When the electricity saving lamp key 62 is depressed again, the image forming apparatus returns to the image formable state and the electricity saving lamp key 62 is turned off. Therefore, the electricity saving lamp key 62 is on only when the image forming apparatus is in the first electricity saving state.

An image forming apparatus 600 according to the second embodiment includes a latent-image forming unit 601 configured to form an electrostatic latent image on a not-shown photoconductive drum, a recording-paper supplying unit 602 configured to supply recording paper, a developing and transferring unit 603 configured to develop, with, for example, a powder toner, the latent image formed by the latent-image forming unit 601 and transfer a toner image onto the recording paper, a fixing unit 604 configured to heat the toner image transferred on the recording paper to thereby fix the toner image, a display unit 503, the power supply panel 504, an operating-face control unit 605 configured to control the display unit 503 and a main power lamp 61m and a power lamp 61p of the power panel 504, a communication unit 606 configured to perform communication with the outside, a power control unit 607 configured to temporarily stop the supply of electric power to the respective units under predetermined conditions explained later, and a main control unit 609 including a pause-time measuring unit 608 therein.

The latent-image forming unit 601, the recording-paper supplying unit 602, the developing and transferring unit 603, and the fixing unit 604 configure an image-formation processing unit.

The pause-time measuring unit 608 in this embodiment is also, for example, a counter configured to start measurement of time immediately after the use of the image forming apparatus 600 ends.

The pause-time measuring unit 608 sends, to the power control unit 607, a pause time signal indicating that a predetermined time, for example, one minute elapses as the measured pause time while the image forming apparatus 600 is not used. The main control unit 609 sends a power key depression signal to the power control unit 607 when the power key 61 is depressed. When the electricity saving lamp key 62 is depressed, the operating-face control unit 605 sends an electricity saving lamp key depression signal to the power control unit 607 through the main control unit 609.

The power control unit 607 receives the pause time signal from the pause-time measuring unit 608 or the power key depression signal or the electricity saving lamp key depression signal and stops the operation of a part of circuits of the image forming apparatus 600.

In this embodiment, in the first electricity saving state, the power control unit 607 stops power supply to only the fixing unit 604 surrounded by a broken line. In the second electricity saving state, the power control unit 607 stops power supply to, for example, a section surrounded by a dotted line, i.e., the latent-image forming unit 601, the recording-paper supplying unit 602, the developing and transferring unit 603, the fixing unit 604, the display unit 503, and the operating-face control unit 605.

In the case of this electricity saving state, the display unit 503 stops operation. Therefore, as at the time when a power supply for the image forming apparatus 600 is off, a screen of the display unit 503 is off. The operating-face control unit 605 also stops. However, a state of the main power lamp 61m and the power supply lamp 61p maintains an on or off state before the stop.

For example, when electric power of voltage 24 V and electric power of voltage 5 V are supplied to the units, in the first electricity saving state, the power control unit 607 stops the power supply to a section to which the power of the voltage 24V is supplied. In the second electricity saving state, the power control unit 607 stops the power supply to all the units except a part of the units to which the power of the voltage 5 V is supplied.

Transition among an image formable state SB, a first electricity saving state S1, and a second electricity saving state S2 in this embodiment is explained with reference to FIG. 7.

When a main power switch is turned on, the image forming apparatus 600 transitions to the image formable state. (a) When the user depresses the power key 61 in this state, the image forming apparatus 600 transitions to the second electricity saving state. (b) When the user depresses the power key 61 in the second electricity saving state, the image forming apparatus 600 returns to the image formable state.

(c) When the user depresses the electricity saving lamp key 62 in the image formable state, the image forming apparatus 600 transitions to the first electricity saving state. (d) When the user depresses the electricity saving lamp key 62 in the first electricity saving state, the image forming apparatus 600 returns to the image formable state. (e) When the user depresses the power key 61 in the first electricity saving state, the image forming apparatus 600 transitions to the second electricity saving state.

(f) When a predetermined time, for example, one minute elapses in the image formable state, the image forming apparatus 600 transitions to the second electricity saving state. (g) When a predetermined time, for example, two minutes elapse in the first electricity saving state, the image forming apparatus 600 transitions to the second electricity saving state.

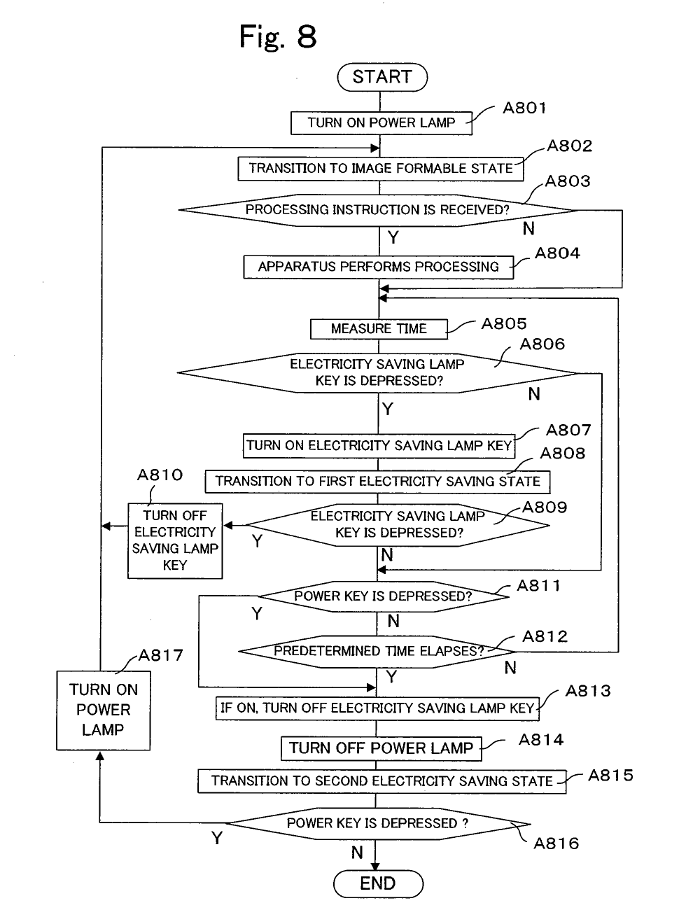

The operation of the image forming apparatus 600 according to the second embodiment is explained below with reference to FIG. 8. In the following explanation of the operation, explanation of operation for turning on and off the main power lamp 61m when the main power switch is turned on and off is not shown in FIG. 8.

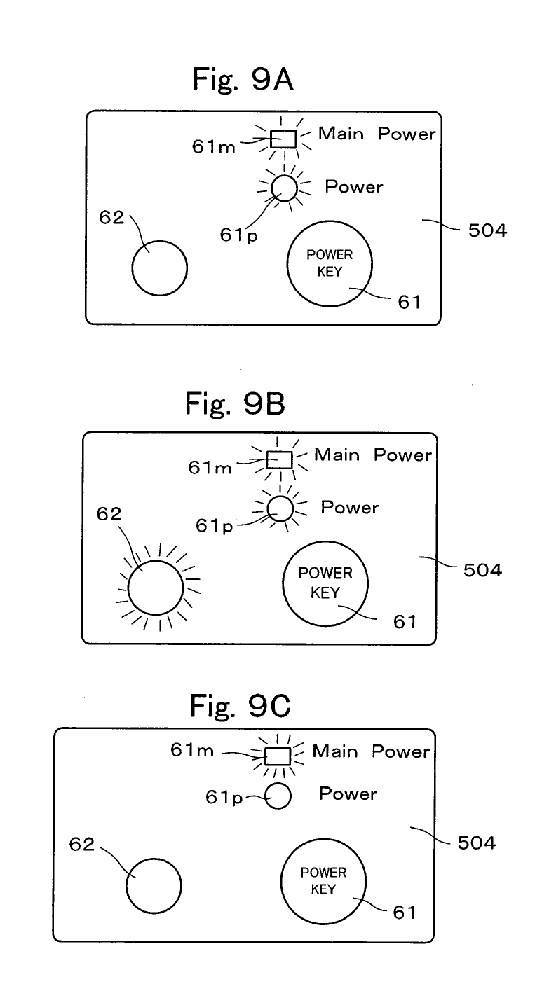

When the main power switch is turned on, the main power lamp 61m is turned on. In Act A801, the power lamp 61p is turned on. In Act A802, the image forming apparatus 600 transitions to the image formable state. In this state, on the power panel 504, as shown in FIG. 9A, the main power lamp 61m and the power lamp 61p are on.

In Act A803, the image forming apparatus 600 detects whether a processing instruction is received from the user. If an instruction for specific processing such as copying is received (Y in Act A803), in Act A804, the image forming apparatus 600 performs the processing. For example, in the case of copying, the image forming apparatus 600 develops, in the developing and transferring unit 603, an electrostatic latent image formed by the latent-image forming unit 601, transfers a toner image onto recording paper supplied from the recording-paper supplying unit 602, fixes the toner image in the fixing unit 604, and discharges the recording paper to the outside.

When the image forming apparatus 600 ends the processing in Act A804 in this way, in Act A805, the pause-time measuring unit 608 starts time measurement immediately after the end of the processing. If an instruction for processing is not received in Act A803 (N in A803), the pause-time measuring unit 608 also performs measurement of time in Act A805.

In the next Act A806, the image forming apparatus 600 detects whether the electricity saving lamp key 62 is depressed. If the electricity saving lamp key 62 is depressed (Y in A806), in Act A807, the image forming apparatus 600 turns on the electricity saving lamp key 62. In Act A808, the image forming apparatus 600 transitions to the first electricity saving state. Specifically, the image forming apparatus 600 stops the supply of electric power to the fixing unit 604. In this state, on the power panel 504, as shown in FIG. 9B, the electricity saving lamp key 62 is also on besides the main power lamp 61m and the power lamp 61p.

In the next Act A809, the image forming apparatus 600 detects whether the electricity saving lamp key 62 is depressed again. If the electricity saving lamp key 62 is depressed (Y in A809), in Act A810, the image forming apparatus 600 turns off the electricity saving lamp key 62, returns to Act A802, and returns to the image formable state.

On the other hand, if the electricity saving lamp key 62 is not depressed in Act A809 (N in A809), the image forming apparatus 600 shifts to Act A811 and detects whether the power key 61 is depressed. When the power key 61 is not depressed, the image forming apparatus 600 shifts to Act A812 and detects whether a predetermined time elapses. The predetermined time is, for example, one minute in the image formable state and two minutes in the first electricity saving state.

If the predetermined time elapses (Y in Act A812), the image forming apparatus 600 shifts to Act A813 and, if the electricity saving lamp key 62 is on, turns off the electricity saving lamp key 62. If the elapse of the predetermined time is not detected (N in Act A812), the image forming apparatus 600 returns to Act A805 and continues the time measurement.

In the next Act A814, the image forming apparatus 600 turns off the power lamp 61p. In Act A815, the image forming apparatus 600 transitions to the second electricity saving state. Therefore, in the second electricity saving state, as shown in FIG. 9C, only the main power lamp 61m is on. In the second electricity saving state, the power control unit 607 stops power supply to a section surrounded by a dotted line, i.e., the latent-image forming unit 601, the recording-paper supplying unit 602, the developing and transferring unit 603, the fixing unit 604, the display unit 503, and the operating-face control unit 605.

Thereafter, in Act A816, the image forming apparatus 600 detects whether the power key 61 is depressed. If the power key 61 is depressed (Y in Act A816), in Act A817, the image forming apparatus 600 turns on the power lamp 61p, returns to Act A802, and transitions to the image formable state.

In the second embodiment of the present invention, an image forming apparatus having the two electricity saving states and having an appropriate power saving effect and appropriate image formation time is obtained. In the second embodiment, when, for example, two minutes elapse while the image forming apparatus is not used, the image forming apparatus transitions to the second electricity saving state. In this state, when the user depresses the power key, the user can always return the image forming apparatus to the image formable state. The power key is the same as a key that the user depresses when the user desires to transition the image forming apparatus from the image formable state to the second electricity saving state. The user can easily switch the state of the image forming apparatus to the second electricity saving state and the image formable state.

In the second embodiment, there is an advantage that, when the user desires to use the image forming apparatus immediately at a relatively short time after the image forming apparatus is stopped, the user can set the image forming apparatus in the first electricity saving state in which time for return to the image formable state is relatively short.

However, in the present invention, it is also possible to set the electricity saving states such that, after the processing ends, the image forming apparatus transitions to, when a first predetermined time t1 elapses, the first electricity saving state in which the power saving effect is small but the time for return to the image formable state is short and thereafter transitions to, when a second predetermined time t2 elapses, the second electricity saving state in which the power saving effect is large but the time for return to the image formable state is long. This makes it possible to reduce the return time when the user immediately uses the image forming apparatus. On the other hand, when the image forming apparatus is not used for certain length of time, the image forming apparatus transitions from the first electricity saving state to the second electricity saving state. Therefore, there is an advantage that it is possible to improve the power saving effect in the image forming apparatus as a whole.

In the second embodiment, as shown in FIGS. 9A and 9C, the power lamp 61p is on in the image formable state and off in the electricity saving state. However, conversely, the power lamp 61p may be off in the image formable state and on in the electricity saving state.

In the second embodiment, the electricity saving lamp key is on in the first electricity saving state. However, in the present invention, an electricity saving key not having a turning-on function may be used.

In the first and second embodiments, the user depresses the power key to change the state of the image forming apparatus between the image formable state and the electricity saving state. However, the power key only has to be a key that can be activated to output an instruction signal without being depressed.

In the first and second embodiments, the image-formation processing unit performs the processing for forming a latent image, then developing the latent image, and thereafter transferring a developed image onto recording paper and fixing the image on the recording paper. However, in the present invention, the image-formation processing unit may perform processing for directly developing and fixing an image on recording paper without transferring the image. In short, the image-formation processing unit only has to perform processing for forming an image.

In the present invention, it is also possible to provide the electricity saving lamp key as in the second embodiment, cause the image forming apparatus to operate as in the first embodiment in an initial state of shipment from a factory and, cause the image forming apparatus to operate later as in the second embodiment by changing a computer program.

Obviously, many, modifications and variations of this invention are possible in the light of the above teachings. It is therefore to be understood that within the scope of the appended claims, this invention may be practiced otherwise than as specification.

What is claimed is:

1. An image forming apparatus comprising:
an image-formation processing unit configured to perform processing for forming an image;
a power control unit configured to control power supply to the image-formation processing unit to make it possible to switch an image formable state for supplying power to enable the image-formation processing unit to immediately perform the processing for image formation and an electricity saving state for reducing the power supply and performing electricity saving; and
a power key configured to be once activated to thereby control the power control unit to transition the image forming apparatus from the image formable state to the electricity saving state and activated again to thereby control the power control unit to return the image forming apparatus from the electricity saving state to the image formable state.

2. The apparatus according to claim 1, wherein the power key is a key configured to be activated by being depressed.

3. The apparatus according to claim 2, wherein the image forming apparatus transitions from the image formable state to the electricity saving state when predetermined time elapses and, after the transition, returns to the image formable state when the power key is depressed.

4. The apparatus according to claim 3, wherein the power key is provided on a power panel provided on an upper surface of the image forming apparatus and configured to perform display of a state of a power supply and an instruction for power supply.

5. The apparatus according to claim 4, wherein a power lamp configured to be turned on or off in the image formable state and turned off or on in the electricity saving state is provided on the power panel.

6. The apparatus according to claim 5, wherein
a display unit configured to indicate a state of the image forming apparatus is provided on the upper surface of the image forming apparatus, and
the display unit is turned off in the electricity saving state.

7. The apparatus according to claim 6, wherein the image-formation processing unit includes:
a latent-image forming unit configured to form a latent image;
a developing unit configured to develop the latent image formed by the latent-image forming unit; and
a fixing unit configured to fix an image developed by the developing unit on recording paper.

8. The apparatus according to claim 7, wherein the electricity saving state includes plural states in which power reduction amounts are different.

9. An image forming apparatus comprising:
an image-formation processing unit configured to perform processing for forming an image;
a power control unit configured to control power supply to the image-formation processing unit to make it possible to switch an image formable state for supplying power to enable the image-formation processing unit to immediately perform the processing for image formation, a first electricity saving state for reducing the power supply and performing electricity saving, and a second electricity saving state for reducing the supply of the power by an amount larger than that in the first electricity saving state; and
a power key configured to be once depressed to thereby control the power control unit to transition the image forming apparatus from the image formable state to the second electricity saving state and depressed again to thereby control the power control unit to return the image forming apparatus from the second electricity saving state to the image formable state.

10. The apparatus according to claim 9, wherein the image forming apparatus transitions from the image formable state to the first or second electricity saving state when predetermined time elapses and, after the transition, returns to the image formable state when the power key is depressed.

11. The apparatus according to claim 10, wherein the image-formation processing unit includes:
a latent-image forming unit configured to form a latent image;
a developing unit configured to develop the latent image formed by the latent-image forming unit; and
a fixing unit configured to fix an image developed by the developing unit on recording paper.

12. The apparatus according to claim 11, wherein power supply to the fixing unit is stopped in the first electricity saving state, and
power supply to the latent-image forming unit, the developing unit, and the fixing unit is stopped in the second electricity saving state.

13. The apparatus according to claim 12, wherein the power key is provided on a power panel provided on an upper surface of the image forming apparatus and configured to perform display of a state of a power supply and an instruction for power supply.

14. The apparatus according to claim 13, wherein the power panel includes an electricity saving key configured to be depressed once to transition the image forming apparatus from the image formable state to the first electricity saving state and, after the image forming apparatus transitions to the first electricity saving state, depressed again to return the image forming apparatus to the image formable state.

15. The apparatus according to claim 14, wherein a power lamp configured to be turned on in the image formable state and turned off in the second electricity saving state is provided on the power panel.

16. The apparatus according to claim 15, wherein
a display unit configured to indicate a state of the image forming apparatus is provided on the upper surface of the image forming apparatus, and
the display unit is turned off in the electricity saving state.

17. A power control method for an image forming apparatus comprising:
depressing a power key once to thereby control a power control unit to transition an image forming apparatus from an image formable state to an electricity saving state, (the image formable state is a state for supplying power to enable the image forming apparatus to immediately perform processing for image formation and the electricity saving state is a state for reducing the power supply and performing electricity saving. The power control unit can control power supply to an image-formation processing unit and switch the image formable state and the electricity saving state); and
depressing the power key again to thereby control the power control unit to return the image forming apparatus from the electricity saving state to the image formable state.

18. The method according to claim 17, wherein the power key is provided on a power panel provided on an upper surface of the image forming apparatus and configured to perform display of a state of a power supply and an instruction for power supply.

19. The method according to claim 18, wherein
a power lamp is provided on the power panel, and
the power lamp is turned on in the image formable state and turned off when the image forming apparatus transitions to the electricity saving state.

20. The method according to claim 19, wherein the electricity saving state includes plural states in which power reduction amounts are different.
